(19) United States
(12) Patent Application Publication
(10) Pub. No.: US 2025/0035836 A1
(43) Pub. Date: Jan. 30, 2025

(54) OVERMOLDING AND OVERCASTING FOR ENCAPSULATING POLYMER REFLECTIVE WAVEGUIDE

(71) Applicant: GOOGLE LLC, Mountain View, CA (US)

(72) Inventors: Ahmed Drammeh, Santa Clara, CA (US); Christophe Peroz, Zurich (CH); Constantin-Christian A. Voll, San Francisco, CA (US); Ali Karbasi, San Jose, CA (US)

(21) Appl. No.: 18/226,069

(22) Filed: Jul. 25, 2023

(51) Int. Cl. F21V 8/00; G02B 27/01

(52) U.S. Cl. CPC G02B 6/0065; G02B 6/0016; G02B 6/0031; G02B 6/0038; G02B 27/0172; G02B 2027/0178

(57) ABSTRACT

Overmolding or overcasting one portion of a reflective waveguide to another portion achieves bonding of components of the reflective waveguide without the need for an index-matched adhesive or an alignment platform for bonding. In embodiments in which one portion is overmolded to the other, the materials used to form the portions are selected such that the material used to form a first portion has a glass transition temperature (Tg) that is higher than the Tg of the material used to form a second portion. In embodiments in which one portion is overcasted to the other, the materials used to form the first portion and the second portion are thermosetting resins and are selected such that both materials have solubility parameters that approximately match each other.

### BACKGROUND

The present disclosure relates generally to reflective waveguides for augmented reality (AR) eyewear displays. In an AR eyewear display, light from an image source is coupled into a light guide substrate, generally referred to as a waveguide, by an input optical coupling such as an in-coupling grating (i.e., an “incoupler”), which can be formed on a surface, or multiple surfaces, of the substrate or disposed within the substrate. Once the light beams have been coupled into the waveguide, the light beams are “guided” through the substrate, typically by multiple instances of total internal reflection, to then be directed out of the waveguide by an output optical coupling (i.e., an “outcoupler”), such as a reflective facet or an optical grating, to an eyebox (i.e., a volume where the eye receives an acceptable view of the image produced by a light engine with respect to a set of criteria and thresholds). The light beams projected from the waveguide overlap at an eye relief distance from the waveguide forming an exit pupil within which a virtual image generated by the image source can be viewed by the user of the eyewear display.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an augmented reality display device implementing overmolded or overcasted reflective waveguide portions in accordance with some embodiments.

FIG. 2 is a diagram illustrating a cross-section view of an example implementation of a waveguide in accordance with some embodiments.

FIG. 3 is a series of diagrams illustrating characteristics of reflective waveguide structures.

FIG. 4 is a diagram illustrating basic functions of an optical combiner in accordance with some embodiments.

FIG. 5 is a diagram illustrating injection compression molding of a first portion of a reflective waveguide in accordance with some embodiments.

FIG. 6 is a flow diagram illustrating a method of fusing a first material forming a first portion of a reflective waveguide and a second material forming a second portion of the reflective waveguide without an adhesive layer in accordance with some embodiments.

FIG. 7 is a flow diagram illustrating a method of overmolding a second material forming a second portion of a reflective waveguide to a first material forming a first portion of the reflective waveguide in accordance with some embodiments.

FIG. 8 is a diagram illustrating overmolding of a second portion of a reflective waveguide to a first portion of a reflective waveguide in accordance with some embodiments.

FIG. 9 is a flow diagram illustrating a method of overcasting a second material forming a second portion of a reflective waveguide to a first material forming a first portion of the reflective waveguide in accordance with some embodiments.

FIG. 10 is a diagram illustrating overcasting of a second portion of a reflective waveguide to a first portion of a reflective waveguide in accordance with some embodiments.

### DETAILED DESCRIPTION

Reflective waveguides can enable high efficiency, small form factor augmented reality (AR) displays with uniform display quality having limited artifacts (low eye glow, low rainbow, etc.). Current manufacturing processes for glass based reflective waveguides for AR displays is complex, involving many iterative process steps, thus limiting the commercialization of reflective waveguides. Further, current fabrication processes using glass substrates require excess material that is typically removed during final formation, resulting in material waste. By contrast, current polymer reflective waveguide fabrication processes use an injection compression molding process in which individual components of the waveguide are formed in a mold, a surface of one component is coated with a dielectric coating, and then the coated surface and the other component are aligned and bonded to each other using an index-matched adhesive layer. The index matching requirements for the adhesive layer are stringent, generally requiring that the refractive index of the adhesive layer match the refractive index of the substrate components within 10⁻⁴ for display light having a wavelength of approximately 550 nm.

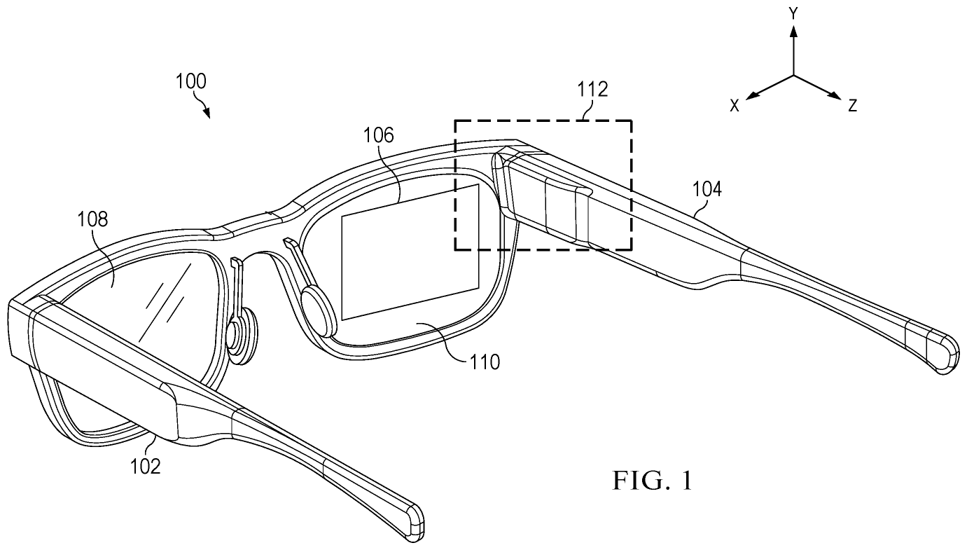

To achieve bonding of components of the reflective waveguide without the need for an index-matched adhesive or an alignment platform for bonding, FIGS. 1-9 illustrate techniques for overmolding or overcasting one component of the reflective waveguide to the other component. Accordingly, by overmolding or overcasting the reflective waveguide components to each other, the number of process steps required to fabricate the polymer-based reflective waveguide are reduced and the fabrication process is simplified without compromising the structural integrity or coatings of the reflective waveguide components. The materials used to form the components of the reflective waveguide have refractive indices that approximately or exactly match each other. In some embodiments, the refractive indices of the material used to form the components differ from each other by less than approximately 10⁻³.

The material used to form a first portion of the reflective waveguide is molded using injection molding or injection compression molding (ICM) in some embodiments. After forming the first portion using ICM, the first portion of the reflective waveguide has two major surfaces. In some embodiments, one of the major surfaces is coated with a dielectric coating.

For embodiments in which a second portion of the reflective waveguide is fused to the first portion by overmolding, both the first material and the second material are thermoplastic polymers. The first portion is placed in an ICM mold cavity with the coated surface exposed and the second material is injected into the mold cavity to contact the coated surface. For overmolding embodiments, the materials used to form the first and second portions are selected such that the material used to form the first portion has a glass transition temperature (Tg) that is higher than the Tg of the material used to form the second portion. Thus, when the second material is overmolded to the first portion, the second material is injected into a mold cavity containing the first portion at a temperature that is higher than the Tg of the second material but lower than the Tg of the first material such that the first portion is not deformed. In some embodiments, the Tg of the second material is at least approximately 30° C. lower than the Tg of the first material.

For embodiments in which the second portion of the reflective waveguide is fused to the first portion by overcasting, both the first material and the second material are thermosetting based monomer resins. The first portion is placed in an ICM mold cavity with the coated surface exposed and the second material is injected into the mold cavity to contact the coated surface and pressure is applied. For overcasting embodiments, the materials used to form the first portion and the second portion are selected such that both materials have solubility parameters that approximately match each other.

FIG. 1 illustrates an example AR eyewear display system 100 implementing a reflective waveguide formed by fusing portions of the waveguide to each other without an adhesive layer in accordance with some embodiments. In some embodiments, the portions of the reflective waveguide are fused using overmolding and in other embodiments, the portions of the reflective waveguide are fused using overcasting. The AR eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 106 at one or both of lens elements 108, 110 supported by the support structure 102. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like.

The support structure 102 further can include one or more batteries or other portable power sources for supplying power to the electrical components of the AR eyewear display system 100. In some embodiments, some or all of these components of the AR eyewear display system 100 are fully or partially contained within an inner volume of support structure 102, such as within the arm 104 in region 112 of the support structure 102. In the illustrated implementation, the AR eyewear display system 100 utilizes an eyeglasses form factor. However, the AR eyewear display system 100 is not limited to this form factor and thus may have a different shape and appearance from the eyeglasses frame depicted in FIG. 1.

One or both of the lens elements 108, 110 are used by the AR eyewear display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the AR eyewear display system 100. Additionally, the waveguide employs an exit pupil expander (EPE) (not shown in FIG. 1) in the light path between the IC and OC, or in combination with the OC, in order to increase the dimensions of the display exit pupil. Each of the lens elements 108, 110 is sufficiently transparent to allow a user to see through the lens elements to provide a field of view of the user's real-world environment such that the image appears superimposed over at least a portion of the real-world environment.

To allow for a smaller, more compact form-factor, in some embodiments, one or more of the IC, OC, and/or EPE use reflective waveguide facets either to reflect light from one surface of the waveguide back to the same surface or to allow light to travel through the facets from one surface of the waveguide to a different, opposing surface of the waveguide. In order to bond portions of the reflective polymer waveguide to each other, conventional techniques impose stringent index matching adhesive requirements. For example, the larger the difference between the refractive index of the adhesive and the refractive index of the waveguide materials, the thinner the adhesive layer must be. In addition, the thickness of the adhesive layer must be uniform across the waveguide grating. Further, the processes for aligned bonding and lamination are relatively complicated. By contrast, using the techniques described herein, portions of the reflective waveguide are bonded directly to each other without the use of an interfacial index matching adhesive layer. Instead, materials used to form the portions of the reflective waveguide are selected to allow overmolding or overcasting to fuse the portions to each other.

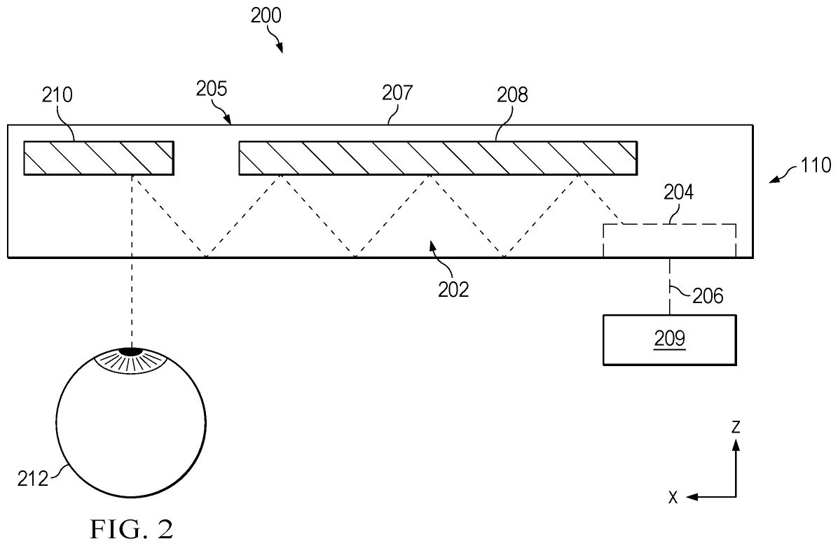

FIG. 2 depicts a cross-section view of an implementation of a display system 200 partially included in a lens element such as lens element 110 of an AR eyewear display system such as AR eyewear display system 100, which in some embodiments comprises a waveguide 202. Note that for purposes of illustration, at least some dimensions in the Z direction are exaggerated for improved visibility of the represented aspects.

The waveguide 202 includes an incoupler 204 and an outcoupler 210. The term “waveguide,” as used herein, will be understood to mean a combiner using one or more of total internal reflection (TIR), specialized filters, and/or reflective surfaces, to transfer light from an incoupler (such as the incoupler 204) to an outcoupler (such as the outcoupler 210). In some display applications, the light is a collimated image, and the waveguide transfers and replicates the collimated image to the eye. In general, an incoupler and outcoupler each include, for example, one or more optical grating structures, including, but not limited to, reflective gratings, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection.

In the present example, the display light 206 received at the incoupler 204 is relayed to the outcoupler 210 via the waveguide 202 using TIR. The display light 206 is then output to the eye 212 of a user via the outcoupler 210. As described above, in some embodiments the waveguide 202 is implemented as part of an eyeglass lens, such as the lens 108 or lens 110 (FIG. 1) of the display system having an eyeglass form factor and employing the display system 200.

In this example implementation, the waveguide 202 implements facets in the region 208 (which provide exit pupil expansion functionality) and facets of the region 210 (which provide OC functionality) toward the world-facing side 207 of the waveguide 202 and the lens element 110, and the facets of the IC 204 are implemented toward the eye-facing side 205 of the lens element 110. Thus, under this approach, display light 206 from a light source 209 is incoupled to the waveguide 202 via the IC 204, and propagated (through total internal reflection in this example) toward the region 208, whereupon the facets of the region 208 reflect the incident display light for exit pupil expansion purposes, and the resulting light is propagated to the facets of the region 210, which output the display light toward a user's eye 212. In other embodiments, the facets of the IC 204 are implemented toward the world-facing side 207 of the lens element 110.

Embodiments of reflective waveguide structures formed according to the techniques described herein achieve uniform display quality with limited artifacts using reflective waveguide facets, as described further hereinbelow. For example, in some embodiments, the facets allow display light to travel through the facets from one surface of the waveguide to a different, opposing surface of the waveguide rather than, e.g., reflecting the light from one surface back onto the same surface. In some embodiments, as described further hereinbelow, the facets are formed to have a desired shape that enables this functionality.

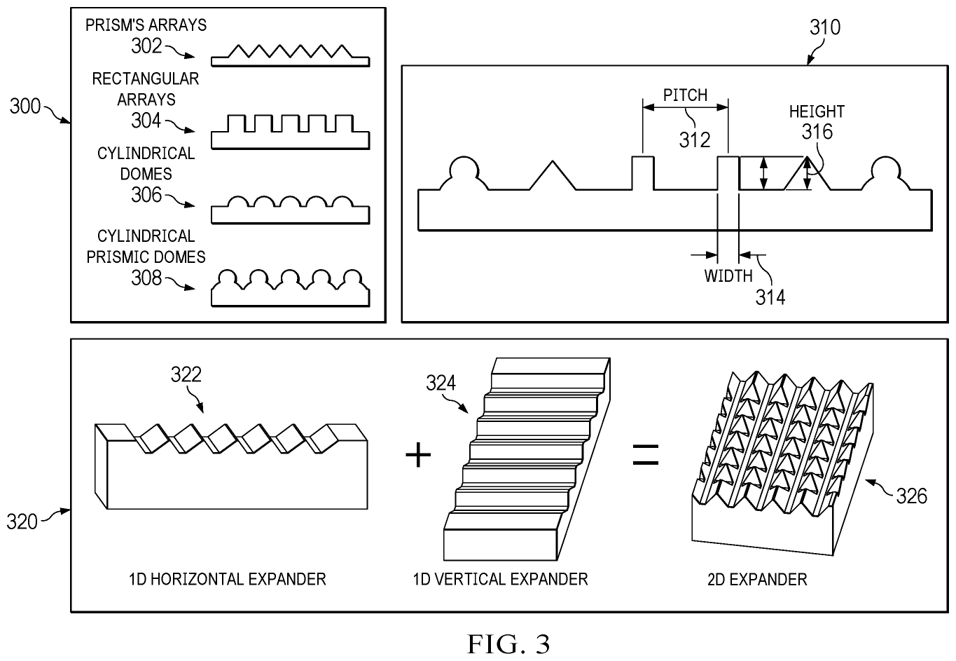

FIG. 3 is a series of diagrams illustrating characteristics of reflective waveguide structures. Diagram 300 illustrates cross-sectional images of arrays of structures used in reflective waveguide embodiments. For example, in some reflective waveguide embodiments, an array of prisms 302 is used to direct light. In other embodiments, a rectangular array 304 is used to direct light. Cylindrical domes 306 are used to direct light in some embodiments, and in other embodiments cylindrical prismic domes 308 are used to direct light. Diagram 310 illustrates characteristics of structures of a reflective waveguide. A pitch 312 characterizes a distance from one structure of an array to the next structure of the array. A width 314 describes the horizontal dimension of a structure of the array, and a height 316 describes the vertical dimension of a structure of the array.

Diagram 320 illustrates different types of exit pupil expanders that employ grating structures. One-dimensional (1D) horizontal exit pupil expander 322 includes horizontal rows of gratings and 1D vertical exit pupil expander 324 includes vertical rows of gratings. If the 1D horizontal EPE and the 1D vertical EPE are combined, they form a two-dimensional EPE 326 that can also function as an outcoupler in some embodiments.

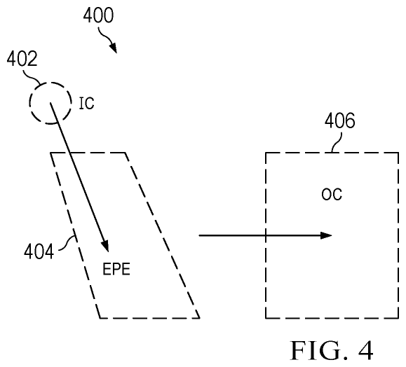

FIG. 4 is a diagram illustrating basic functions of an optical combiner 400 in accordance with some embodiments. A waveguide-based optical combiner (or “waveguide combiner”) is often used in AR-based near-eye displays to provide a view of the real world overlayed with static imagery or video (recorded or rendered). As illustrated in FIG. 4, such optical combiners typically employ an IC 402 to receive display light from a display source (not shown), an EPE 404 to increase the size of the display exit pupil, and an OC 406 to direct the resulting display light toward a user's eye. In some embodiments, the formation of reflective waveguide facets within one or more of the IC 402, the EPE 404, and the OC 406 is achieved by injection molding a first material to form a first portion (also referred to as a first wafer) having a series of facets with a desired shape, coating the facets with a partially reflective dielectric coating, and overmolding or overcasting a second material to the first wafer to form a second portion (also referred to as a second wafer) that is fused to the first wafer without an interfacial index matched adhesive layer.

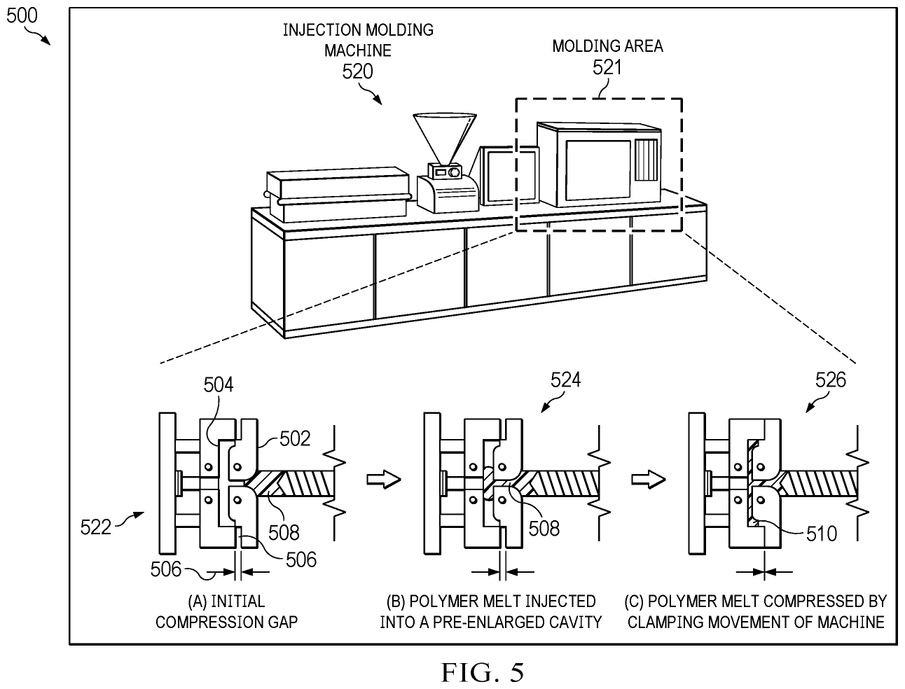

FIG. 5 is a diagram illustrating a process 500 for injection compression molding of a first portion of a reflective waveguide in accordance with some embodiments. An injection molding machine 520 includes a molding area 521 that is shown in exploded views in first, second, and third ICM steps 522, 524, and 526. In a first ICM step 522, a mold 502 forming a cavity 504 is in an open position, with an initial compression gap 506 separating two sides of the mold 502.

At a second ICM step 524, polymer melt of a first material 508 is injected into the cavity 504. The first material 508 is heated to a temperature higher than the Tg of the first material so the first material 508 can flow into the cavity 504.

At a third IC step 526, the polymer melt of the first material 508 is compressed by a clamping movement of the ICM machine 520 such that the initial compression gap 506 is minimized or eliminated to form the first wafer 510. The first wafer 510 takes the shape of the mold 502, such that facet structures included in the mold 502 are imprinted onto the first wafer 510. In some embodiments, the first wafer 510 is formed using standard injection molding.

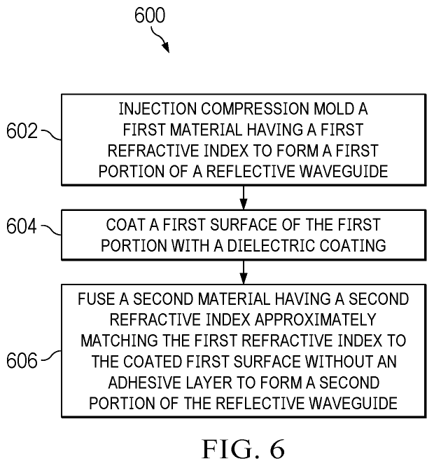

FIG. 6 is a flow diagram illustrating a method 600 of fusing a first material forming a first portion of a reflective waveguide and a second material forming a second portion of the reflective waveguide without an adhesive layer in accordance with some embodiments. At block 602, a first material having a first refractive index is injection molded or injection compression molded to form a first portion of a reflective waveguide.

At block 604, a first surface of the first portion of the reflective waveguide is coated with a dielectric coating. In some embodiments, the first surface is masked before coating such that some portions of the first surface are coated with the dielectric coating and other portions of the first surface are left uncoated.

Once the first surface of the first portion has been coated, the method flow continues to block 606, At block 606, the reflective structures of the first wafer are encapsulated in the reflective waveguide by fusing a second material to the first portion to form a second portion (also referred to as a second wafer) of the reflective waveguide without an adhesive layer, either by overmolding, in some embodiments, or by overcasting, in other embodiments. The refractive index of the second material is closely matched to the refractive index of the first material.

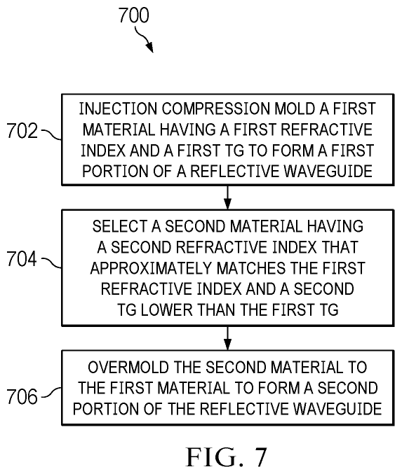

FIG. 7 is a flow diagram illustrating a method 700 of overmolding the second material forming the second portion of the reflective waveguide to the first material forming the first portion of the reflective waveguide in accordance with some embodiments. In some embodiments, the first material and the second material are selected for having chemical compatibility, such that they have an affinity toward each other at a molecular level and will not delaminate once they are overmolded to each other. In addition, because there are discontinuous facet structures on the surface of the first portion, the material used to form the first portion is selected to withstand the overmolding process, so that the structures will not be deformed when the second material is overmolded to the first portion.

Accordingly, at block 702, the first material, which has a first refractive index and a first Tg, is injection molded or injection compression molded to form the first wafer 510. In some embodiments, a major surface of the first wafer is coated with a dielectric coating.

At block 704, a second material is selected to form the second wafer. The second material is selected based on having a second refractive index that approximately matches the first refractive index of the first material and a second Tg that is lower than the first Tg of the first material. For example, in some embodiments, the difference between the refractive index of the first material (n₁) and the refractive index of the second material (n₂) is equal to or less than 10⁻⁴. In some embodiments, 10⁻⁴≤Δn_{1,2}≤10⁻³. In some embodiments, the first material and the second material are characterized by Tgs that are sufficiently different from each other to allow for overmolding of the second material without deforming the first portion. Thus, the high heat and pressure of the overmolding process is sufficient to melt the second material without impacting the integrity of the reflective facet structures (including a dielectric coating) formed on the first portion. In some embodiments, the glass transition temperature of the first material (Tg₁) is higher than the glass transition temperature of the second material (Tg₂) by at least approximately 50° C. In some embodiments, 25° C.≤ΔT_{g}≤50° C.

Table 1 illustrates two examples of materials suitable for overmolding a second wafer to a first wafer.

TABLE 1

| | | | | | Mold temp | Melt temp |
|---|---|---|---|---|---|---|
| | Tg | | Refractive index | | Tg_{material 1} − | Tg_{material 1} + |
| Criteria | Material 1 | Material 2 | Material 1 | Material 2 | 50° C. ± 15° C. | 100° C. ± 15° C. |
| Example 1 | 135° C. | 85° C. | 1.502 | 1.503 | 70° C.-100° C. | 220° C.-250° C. |
| | | | | | (nominal: 85° C.) | (nominal: 235° C.) |
| Example 2 | 142° C. | 118° C. | 1.516 | 1.518 | 77° C.-107° C. | 227° C.-257° C. |
| | | | | | (nominal: 92° C.) | (nominal: 240° C.) |

Suitable materials for the first material and the second material include but are not limited to Polymethyl methacrylate (PMMA), Poly Methyl acrylate (PMA), Poly Methyl benzyl acrylate (PMBA), Polycarbonate, (PC), Polyesters (PET), Bio-based PC, Amorphous Polyamides (APA's), Cyclic olefin copolymers (COC & COPs), cellulose acetate butyrate (CABs), cellulose acetate propionate (CAPs), Polyether-block amide (PEBAX), Thermoplastic polyurethanes (TPU's) and other materials of similar chemistry and properties.

Thermal properties that are considered in selecting materials for the first wafer and the second wafer in some embodiments include Tg and a heat deflection temperature (HDT) (also referred to as a heat distortion temperature). The HDT is the temperature at which a polymer sample deforms under a specified load and can help inform mechanical deformation behavior of the molded part. Although the HDT is not as clearly defined as the glass transition temperature, it is on average 15-20 degrees below the Tg. Therefore, an inference on the overmolding processes success can also be defined such that the HDT is ideally: ΔHDT_{1,2}=/HDT_{wafer1}−HDT_{wafer2}/≥50° C. but can also be relaxed to (25° C.≤ΔHDT≤50° C.).

Thermal properties of some candidate materials for injection compression and overmolding are set forth in Table 2 below.

TABLE 2

| | Glass | | Heat | |
|---|---|---|---|---|
| | transition | | deflection | |
| Material | (Tg) | | (HDT) | |
| Polymethyl methacrylate (PMMA) | ~125° | C. | 100-105° | C. |
| Polycarbonate (PC) | ~150° | C. | 125-130° | C. |
| Polyamides (APA's) | ~140° | C. | 110-120° | C. |
| Bio-based-Durabio 6350 PC | ~105° | C. | 85-95° | C. |
| Bio-based-Durabio 5360 PC | ~85° | C. | 60-65° | C. |
| Poly Methyl benzyl acrylate (PMBA) | ~135° | C. | 110-120° | C. |
| Cyclic olefin copolymers (COC & COPs) | ~140° | C. | 120-125° | C. |

At block 706, the second material is overmolded to the first wafer to form a second portion (second wafer) of the reflective waveguide. By selecting the first material and the second material to have an affinity for each other, to have matching refractive indices, and to have sufficiently different Tgs, the overmolding process fuses the second material to the first wafer without deforming the facet structures of the first wafer and without requiring an alignment platform or index matched adhesive layer.

In a first example, in some embodiments, the first material is a PMBA (Material A) having a refractive index of 1.502, a Tg of approximately 135° C., and a HDT of approximately 119° C. The first material is injection compression molded to form a first wafer, and a second material (Material B) having a refractive index of 1.503, a Tg of approximately 85° C., and a HDT of approximately 65° C. is overmolded to the first wafer. Such a selection of materials and order of processing to fabricate the reflective waveguide results in strong adhesion between the two wafers and maintains the geometric integrity of facets formed on the first wafer during overmolding.

In a second example, the first material and the second material have similar refractive indices but slightly different thermal properties. As with the previous example, the first material is a low birefringence polymer PMBA (Material A) having a refractive index of 1.502, a Tg of approximately 135° C., and a HDT of approximately 119° C. The first material is injection compression molded to form a first wafer, and a second material (Material C) having a refractive index of 1.504, a Tg of approximately 105° C., and a HDT of approximately 85° C. is overmolded to the first wafer to form an encapsulated lens (i.e., the reflective waveguide).

In a third example, the first material is a nylon (Material D) having a refractive index of 1.516, a Tg of approximately 142° C., and a HDT of approximately 120° C. The first material is injection compression molded to form a first wafer, and a second material (Material E) having a refractive index of 1.518, a Tg of approximately 118° C., and a HDT of approximately 100° C. is overmolded to the first wafer to form the reflective waveguide.

As shown in Table 3 below, in each of the foregoing examples, the refractive indices of the two materials forming the wafers are matched to within Δn_{1,2}<10⁻³ and the difference between the glass transition temperatures Tg of the two materials is at least ΔTg_{1,2}≥30° C. to ensure mechanical stability of the structures formed on the first wafer. In addition, and more importantly, the polymers used for the two materials have an affinity toward each other to ensure adhesion after molding.

TABLE 3

| First material | Second material | | ΔTg_{1, 2} ≥ |
|---|---|---|---|
| (ICM wafer) | (substrate overmolding) | Δn_{1, 2} | 30° C. |
| Material A | Material B | 0.001 | ~50° C. |
| Material A | Material C | 0.002 | ~30° C. |
| Material D | Material E | 0.002 | ~30° C. |

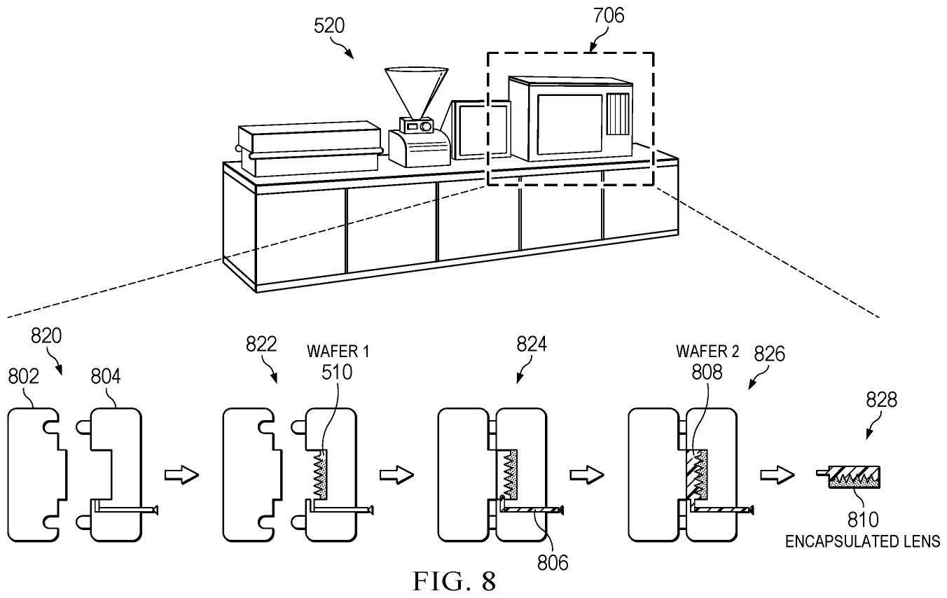

FIG. 8 is a diagram illustrating the overmolding of a second portion of a reflective waveguide to a first portion of a reflective waveguide as discussed with respect to block 706 of FIG. 7 in accordance with some embodiments. At step 820, a mold having faces 802 and 804 of the injection molding machine 520 is open. In some embodiments, the temperature of the mold is Tg_{material 1}−50° C.±15° C.

At step 822, the first wafer 510 (which was previously molded at block 702) is placed in the cavity of the mold. At step 824, the mold is closed to form a predetermined cavity volume in which the second wafer will be formed. A polymer melt 806 of the second material is prepared to inject the melted second material over the first wafer in the cavity of the mold. In some embodiments, the temperature of the polymer melt 806 of the second material is Tg_{material 1}+100° C.±15° C. At step 826, the polymer melt 806 of the second material is injected over the first wafer and fills the cavity to form a second wafer 808. At step 828, the encapsulated lens 810 forming the reflective waveguide is ejected from the mold.

Whereas overmolding fuses materials together without the need for an adhesive layer, overmolding is limited to thermoplastic polymers. In some embodiments, the two portions of a reflective waveguide are fused through an overcasting process rather than an overmolding process. Overcasting uses thermosetting-based resins and exerts significantly lower thermo-mechanical stresses on the first wafer than the overmolding process. In some embodiments, the same material is used for the first wafer and the second wafer for an overcasting process, resulting in an exact match of refractive indices of the two wafers. In other embodiments, the polymers used for the two wafers differ chemically but have closely related solubility parameters (cohesive energy densities).

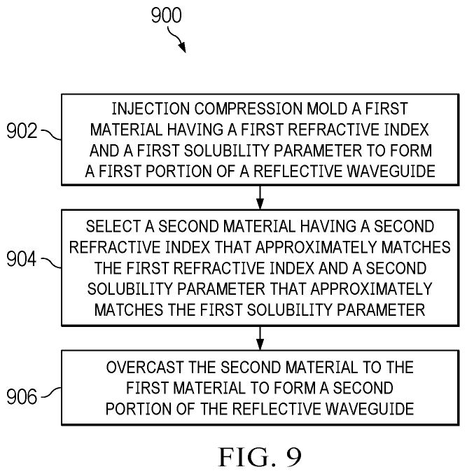

FIG. 9 is a flow diagram illustrating a method 900 of overcasting a second material forming a second portion of a reflective waveguide to a first material forming a first portion of the reflective waveguide in accordance with some embodiments. Similar to the overmolding process described with respect to FIG. 7, at block 902, the first material, which has a first refractive index and a first solubility parameter, is injection molded or injection compression molded to form the first wafer 510. In some embodiments, a major surface of the first wafer (e.g., the major surface on which the facet structures are imprinted) is coated with a dielectric coating.

At block 904, a second material is selected to form the second wafer. The second material is selected based on having a second refractive index that approximately matches the first refractive index of the first material and a second solubility parameter that approximately matches the first solubility parameter of the first material. Based on thermodynamics, solubility or a polymer-to-polymer interaction occurs when the free energy of mixing is negative:

$$0 > Δ {F}_{M} = Δ {H}_{M} - T Δ {S}_{M}$$

where T is the absolute temperature and ΔH and ΔS are the enthalpy and entropy of mixing, respectively. For polymer-to-polymer adhesion to occur, ΔH must be close or equal to zero. The entropy of a system is typically always increasing and positive. The solubility parameter is related to ΔH as follows:

$$Δ {H}_{M} = {V}_{1} {{V}_{2} ( {δ}_{1} - {δ}_{2} )}^{2}$$

where δ₁ and δ₂ are the solubility parameters for the first material and the second material, respectively, and V₁ and V₂ are the volume fractions for each of the materials involved. To ensure strong adhesion, in some embodiments, Δδ≅0. In other embodiments, in which different polymers are used for the two materials, Δδ≤1.

At block 906, the second material is overcast to the first material to form a second wafer (i.e., portion) of the reflective waveguide. As with overmolding, selection of materials (e.g., thermosetting resins) for overcasting determines the adhesive properties of the reflective waveguide. Suitable materials for the first material and the second material for overcasting include but are not limited to polyurethanes and polyureas (Trivex & Tribrid-PPG), diethylene glycol bis (allyl carbonate) (Orma), thiourethane and episulfides (Mitsui) and other materials of similar chemistry and properties. Table 4 sets forth thermosetting material candidates for the overcasting process.

TABLE 4

| | Refractive | Solubility parameter |
|---|---|---|
| Material | index (n) | (δ) MPA |
| Polyurethanes/ureas | 1.530 | δₛ = 17.4-20 |
| (PUs) - i.e: TRIVEX | | |
| Diethylene glycol bis-allyl | 1.502 | δₛ = 20.4-23 |
| carbonate (ORMA) | | |
| Polythiol Urethanes (MR10) | 1.665 | δₛ = 20.5-22.8 |
| Polythiol Urethanes (MR174) | 1.738 | δₛ = 23.5-26 |

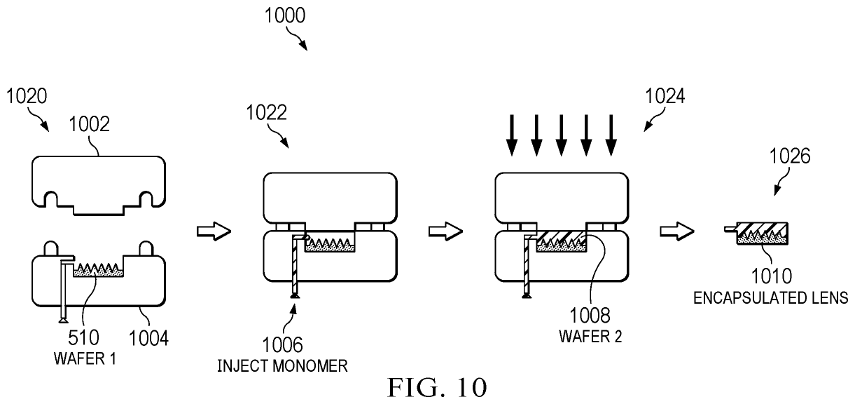

FIG. 10 is a diagram 1000 illustrating overcasting of a second portion of a reflective waveguide to a first portion 510 of a reflective waveguide as discussed with respect to block 906 of FIG. 9 in accordance with some embodiments. At step 1020, a mold having faces 1002 and 1004 is open and the first wafer 510 (which was previously molded at block 902) is placed in the cavity of the mold. At step 1022, the mold is closed to form a predetermined cavity volume in which the second wafer will be formed. A monomer 1006 of the second material is prepared to be injected into the cavity of the mold over the first wafer. At step 1024, the monomer 1006 of the second material is injected over the first wafer and fills the cavity to form the second wafer 1008 while pressure is applied. At step 1026, the encapsulated lens 1010 forming the reflective waveguide is ejected from the mold.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
molding a first material having a first refractive index to form a first portion of a reflective waveguide; and
fusing a second material to the first material without an adhesive layer to form a second portion of the reflective waveguide, the second material having a second refractive index that approximately matches the first refractive index.

2. The method of claim 1, further comprising:
coating a first surface of the first portion of the reflective waveguide with a dielectric coating.

3. The method of claim 1, wherein the first refractive index and the second refractive index differ by less than approximately 10⁻³.

4. The method of claim 1, wherein the first material has a first glass transition temperature (Tg) and the second material has a second Tg lower than the first Tg.

5. The method of claim 4, wherein the second Tg is lower than the first Tg by at least 30 degrees Celsius.

6. The method of claim 1, wherein fusing the second material to the first material comprises overmolding the second material to the first material.

7. The method of claim 1, wherein fusing the second material to the first material comprises overcasting the second material to the first material.

8. The method of claim 7, wherein the first material has a first solubility parameter and the second material has a second solubility parameter that approximately matches the first solubility parameter.

9. A method, comprising:
molding a first material to form a first portion of a reflective waveguide;
coating a first surface of the first portion with a dielectric coating; and
fusing a second material to the coated first surface without an adhesive layer to form a second portion of the reflective waveguide.

10. The method of claim 9, wherein the first refractive index and the second refractive index differ by less than approximately 10⁻³.

11. The method of claim 9, wherein fusing the second material to the coated first surface comprises overmolding the second material to the coated first surface.

12. The method of claim 11, wherein the first material has a first glass transition temperature (Tg) and the second material has a second Tg lower than the first Tg by at least 30 degrees Celsius.

13. The method of claim 9, wherein fusing the second material to the coated first surface comprises overcasting the second material to the coated first surface.

14. The method of claim 13, wherein the first material has a first solubility parameter and the second material has a second solubility parameter that approximately matches the first solubility parameter.

15. A reflective waveguide, comprising:
a first portion comprising a first material having a first refractive index; and
a second portion comprising a second material, the second portion fused to the first portion without an adhesive layer and having a second refractive index that approximately matches the first refractive index.

16. The reflective waveguide of claim 15, wherein the first refractive index and the second refractive index differ by less than approximately 10⁻³.

17. The reflective waveguide of claim 15, wherein the second material is overmolded to the first portion.

18. The reflective waveguide of claim 17, wherein the first material has a first glass transition temperature (Tg) and the second material has a second Tg that is lower than the first Tg by at least 30 degrees Celsius.

19. The reflective waveguide of claim 15, wherein the second material is overcast to the first portion.

20. The reflective waveguide of claim 19, wherein the first material has a first solubility parameter and the second material has a second solubility parameter that approximately matches the first solubility parameter.
